(19) United States
(12) Patent Application Publication
(10) Pub. No.: US 2026/0132866 A1
(43) Pub. Date: May 14, 2026

(54) SYSTEM AND METHOD FOR SYNCHRONIZING STRAIN DATA AND SWITCH DATA FOR MOTOR OPERATED VALVES

(71) Applicant: Crane Nuclear PFT Corp., Kennesaw, GA (US)

(72) Inventors: David Morlan, Kennesaw, GA (US); Hung Hua, Kennesaw, GA (US); Stan Hale, Kennesaw, GA (US)

(21) Appl. No.: 19/384,916

(22) Filed: Nov. 10, 2025

Related U.S. Application Data
(60) Provisional application No. 63/718,475, filed on Nov. 8, 2024.
(60) Provisional application No. 63/718,481, filed on Nov. 8, 2024.
(60) Provisional application No. 63/718,485, filed on Nov. 8, 2024.

(51) Int. Cl. F16K 37/00; G01M 13/003

(52) U.S. Cl. CPC F16K 37/0041; G01M 13/003

(57) ABSTRACT

A system for continuously monitoring a motor operated valve within a nuclear power plant comprises at least one strain acquisition hardware and sensor located on the motor operated valve for detecting strain data associated with the motor operated valve and generating first test data responsive thereto. A switch actuation sensor is remotely located from the motor operated valve for detecting actuation of a switch for actuating operation of the motor operated valve and generating second test data responsive thereto. A server is connected to the at least one strain acquisition hardware and sensor and the switch actuation sensor for associating the first test data and the second test data with a same actuation event and storing the associated test data. A memory stores the associated first test data and the second test data and a network provides communications between the at least one strain acquisition hardware and sensor, the switch actuation sensor and the server.

### CROSS-REFERENCE TO RELATED APPLICATION AND PRIORITY CLAIM

This application claims priority under 35 U.S.C. § 119(e) to U.S. Provisional Patent Application Nos. 63/718,475, 63/718,481, 63/718,485, filed on Nov. 8, 2024, which is hereby incorporated by reference in its entirety.

### TECHNICAL FIELD

This disclosure relates generally to monitoring of test data for motor operated valves in nuclear power plants. More specifically, this disclosure relates to synchronizing monitored strain data and switch data for motor operated valves.

### BACKGROUND

Motor operated valves (MOVs) are used within nuclear power plant facilities for controlling the flow of various materials within the system. The current process of MOV data acquisition to monitor valve operating conditions requires specialized personnel to travel and remain on-site to install temporary sensor equipment and process data for a long period of time. This process is very cumbersome and time-consuming. There is also a potential that crucial test data is not collected during the time window that the personnel is on-site if problems occur at a different time than when the test data is being collected. Thus, there is a need for an automatic data collection system for MOVs within nuclear power plants that obtains the same type of data acquired by the specialized personnel during limited testing periods.

### SUMMARY

One general aspect includes at least one strain acquisition hardware and sensor located at the motor operated valve for generating strain data responsive to actuation of the motor operated valve. The at least one strain acquisition hardware also includes at least one switch actuation sensor separate from the at least one strain acquisition hardware and sensor for generating switch actuation data responsive to actuation of a switch of the motor operated valve; a valve monitoring server for receiving the strain data from the strain acquisition hardware and sensor and the switch actuation data from the at least one switch actuation sensor, where the valve monitoring server is configured to process the received strain data and the received switch actuation data to provide precision alignment in time of the separately generated strain data and switch actuation data; and a network for enabling transfer of the strain data and the switch actuation data between the at least one strain acquisition hardware and sensor, the at least one switch actuation sensor and the valve monitoring server.

A further general aspect includes a system for actuating recording of valve test data for a motor operated valve associated with a nuclear power plant. The system also includes at least one strain acquisition hardware and sensor for continuously recording strain data associated with the motor operated valve; at least one strain acquisition hardware and sensor buffer each associated with the at least one strain acquisition hardware and sensor for storing the continuously recorded strain data on a temporary basis, a switch actuation sensor for continuously recording switch actuation data associated with the motor operated valve, a switch actuation sensor buffer associated with the switch actuation sensor for storing the continuously recorded switch actuation data on a temporary basis, a valve monitoring server in communication with the at least one strain acquisition hardware and sensor and the switch actuation sensor, and where each of the at least one strain acquisition hardware and sensor switch actuation sensor and the switch actuation sensor are responsive to a triggering event to store and transmit a portion of the recorded strain data in the at least one strain acquisition hardware and sensor buffer and a portion of the recorded switch actuation data in the switch actuation sensor buffer to the valve monitoring server.

Another general aspect includes a system for continuously monitoring a motor operated valve within a nuclear power plant. The system also includes at least one strain acquisition hardware and sensor located on the motor operated valve for detecting strain data associated with the motor operated valve and generating first test data responsive thereto; a switch actuation sensor remotely located from the motor operated valve for detecting actuation of a switch for actuating operation of the motor operated valve and generating second test data responsive thereto; a server connected to the at least one strain acquisition hardware and sensor and the switch actuation sensor for associating the first test data and the second test data with a same actuation event and storing the associated test data; a memory for storing the associated first test data and the second test data; and a network for providing communications between the at least one strain acquisition hardware and sensor, the switch actuation sensor and the server.

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates a motor operated valve (MOV);

FIG. 2 illustrates a network for monitoring the operation of an MOV;

FIG. 3 illustrates the components for a system for monitoring the operation of an MOV;

FIG. 4 illustrates a block diagram of a strain acquisition hardware and sensor(s) ;

FIG. 5 illustrates a block diagram of a switch monitoring sensor;

FIG. 6 illustrates the placement of the strain acquisition hardware and sensor(s) with respect to a MOV;

FIG. 7 illustrates the manner for connecting the strain acquisition hardware and sensor(s) to an MOV;

FIG. 8 illustrates a number of alternative embodiments for connecting the strain acquisition hardware and sensor(s) to the MOV;

FIG. 9 illustrates a number of options for connecting the switch monitoring sensor to the system;

FIG. 10 illustrates an alternative embodiment for connecting the strain acquisition hardware and sensor(s) and the switch monitoring sensor to the MOV;

FIG. 11 illustrates various configurations for establishing synchronization between sensors and the valve monitoring server;

FIG. 12 illustrates a flow diagram of the process for synchronizing data from the strain acquisition hardware and sensor(s) and the switch monitoring sensor;

FIG. 13 illustrates the manner for buffering data within sensors and transmitting data packets to a server responsive to a triggering event;

FIG. 14 illustrates a flow diagram of the process for actuating sensor data recordal and transmission to a server;

FIG. 15 illustrates various trigger events used to actuate the dual sensors of the system; and

FIG. 16 illustrates readings from strain acquisition hardware and sensor(s) and switch actuation sensor responsive to various operations.

### DETAILED DESCRIPTION

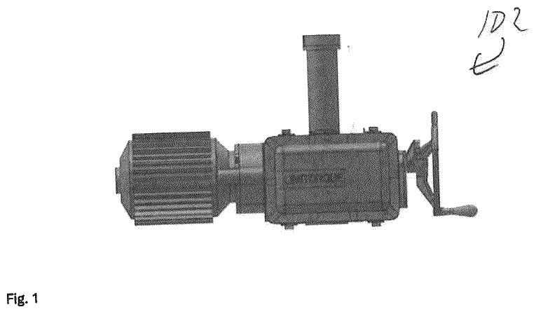

Referring now to the drawings, and more particularly to FIG. 1, there is illustrated a motor operated valve (MOV) 102 that is used within a nuclear power plant. Multiple MOVs 102 would be utilized within a nuclear power plant. As noted above, there is a need to periodically test the valves in order to ensure that they are functioning correctly. Normally this testing procedure requires an individual to connect testing equipment to each MOV 102 and measure data from the MOV. This is a time consuming process. The present disclosure envisions a system for continuously monitoring the MOVs 102 using sensors permanently connected to the MOVs 102 in order to obtain the necessary data at any point in time. Another potential implementations is for the system to NOT continuously record the data (switch or strain) but rather to monitor the data (without recording) and “wake up” in the event of a trigger.

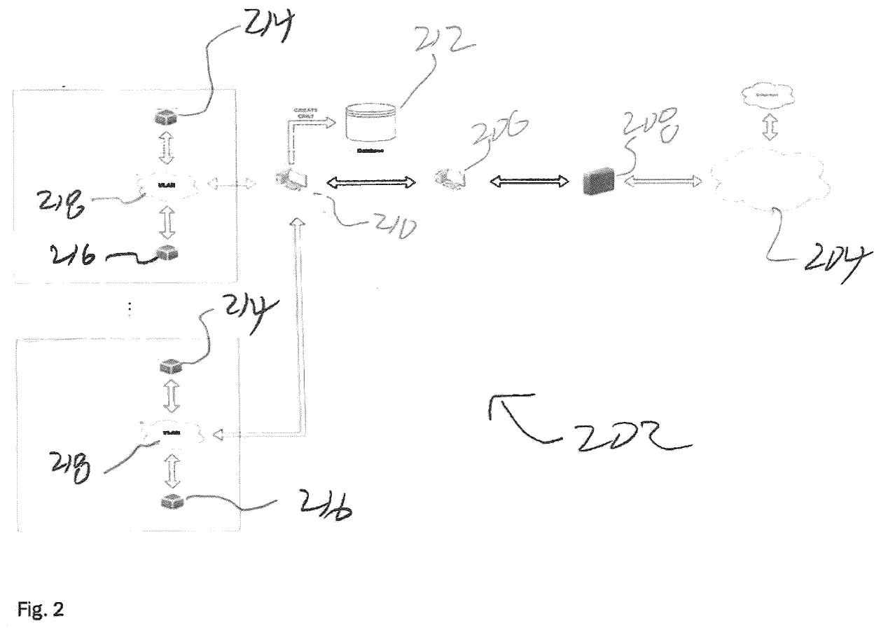

Referring now to FIG. 2, there is illustrated a networking diagram of the system for continuously monitoring MOVs 102. The system 202 uses the nuclear plants internal networking infrastructure to enable communication between data acquisition units (DAUs) and the server software to enable continuous online valve monitoring and diagnostics. The nuclear plant network 204 is connected to a Votes Infinity server 206 through a firewall 208. The Votes Infinity server 206 connects with the valve monitoring server 210. The valve monitoring server 210 has a database 212 associated therewith for storing testing results received from various DAUs.

The server 210 communicates with multiple DAUs that are each associated with a different MOV 102. Each DAU consist of a strain acquisition hardware and sensor(s) 214 located at the MOV that detects movement of the valve within the MOV 102 and a switch actuation sensor 216 remotely located from the MOV that detects actuation of the switch associated with the MOV 102. The strain acquisition hardware and sensor(s) 214 and the switch actuation sensor 216 communicate through a VLAN 218 (Virtual Local Area Network) with the valve monitoring server 210. The VLAN 218 provides for a dedicated network for communicating the test data from the strain acquisition hardware and sensor(s) 214 and the switch actuation sensor 216 to the server 210 and command signals to the strain acquisition hardware and sensor(s) and the switch actuation sensor to be transmitted from the valve monitoring server 210. The VLAN 218 may be configurable to be turned on and turned off for situations wherein the network hardware of the nuclear power plant containing the MOVs 102 utilizes a communications protocol enabling the sensors 214/216 and server 210 to synchronize the separate test data from the sensors without using the VLAN 218.

Each MOV 102 will have a separate strain acquisition hardware and sensor(s) 214 and switch actuation sensor 216. The strain acquisition hardware and sensor(s) 214 comprises a permanently installed sensor at the MOV 102. The switch actuation sensor 216 comprises a remotely located sensor that detects the system applying power to the MOV 102. The sensor 216 shall accommodate up to a 12 AWG wire and measure up to one amp of current. The placement and configuration of the strain acquisition hardware and sensor(s) 214 and switch actuation sensor 216 will be more fully discussed herein below. The valve monitoring server 210 receives the data from the sensors 214 and 216 and aligns and stores the information within a memory.

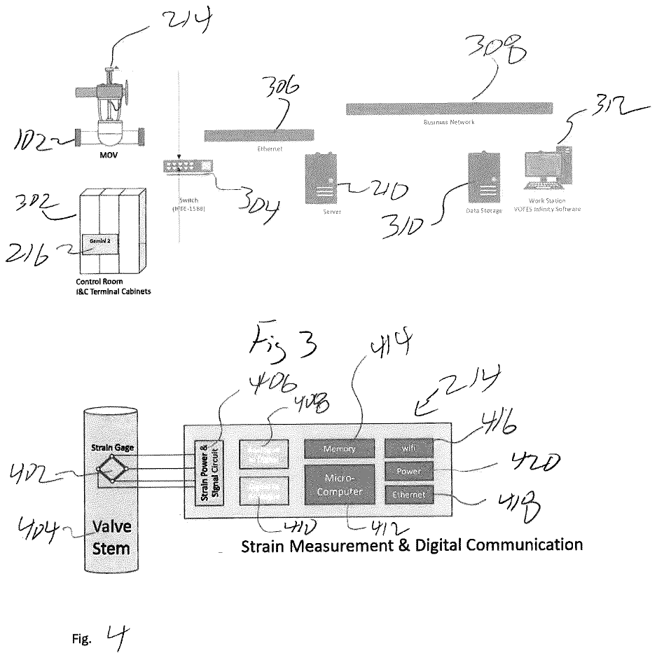

Referring now to FIG. 3, there is illustrated the MOV monitoring system components implemented within the network of a nuclear power plant. The strain acquisition hardware and sensor(s) 214 is directly connected to the MOV 102 and generates strain data from the MOV 102. The switch actuation sensor 216 can be mounted anywhere along the control circuit where access exists (control room, terminal box, at the valve, motor control center, etc.) and detects the actuation of the switch to actuate the MOV 102. Network Switch 304 is connected to the strain acquisition hardware and sensor(s) 214 and the switch actuation sensor 216 in order to provide communications over an ethernet 306 with the valve monitoring server 210. The valve monitoring server 210 interconnects with the system network 308 of the nuclear powerplant and enables storage of test data from the strain acquisition hardware and sensor(s) 214 and the switch actuation sensor 216 within a data storage unit 310. The test data within the data storage unit 310 and the valve monitoring server 210 may be accessed through a workstation 312 of the nuclear power plant as test data.

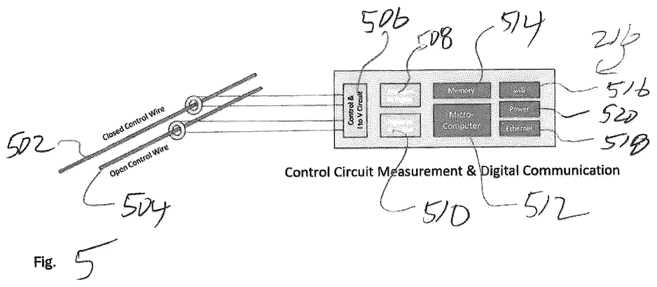

Referring now to FIG. 4, there is illustrated a block diagram of the strain acquisition hardware and sensor(s) 214. The strain acquisition hardware and sensor(s) 214 connects to a strain gauge 402 associated with the valve stem 404 used for opening and closing the valve of the MOV 102. Strain power and signaling circuit 406 is connected to the strain gauge 402 and detects the strain signals generated by the strain gauge 402. An analog to digital converter 408 converts the detected signals from the strain power and signal circuit 406 from analog to digital format. The digital to analog converter 410 converts digital control signals received from a microcomputer 412 into analog format for use by the strain power and signal circuit 406. A memory 414 is used for storing test data detected by the strain gauge 402. This test data may be stored permanently for eventual download to the valve monitoring server 210 or may comprise a buffer for temporarily storing data that is being continuously detected by the strain gauge 402. The microcomputer 412 controls the operation of the strain acquisition hardware and sensor(s) 214 and is responsible for recording and storing data from the strain gauge 402 within the memory 414. The strain acquisition hardware and sensor(s) 214 may communicate with the VLAN 218 or nuclear powerplant network through a WiFi interface 416 or wireline ethernet interface 418. Power is provided to the strain acquisition hardware and sensor(s) 214 through power circuitry/interface 420.

The strain acquisition hardware and sensor(s) 214 provides signal conditioning and the means to record up to four strain gauge signals. The signal conditioning is configured to match strain gauge parameters. The analog to digital converter 408 and digital to analog converter 410 digitizes and time stamps each data point of the multiple strain signals received from the strain gauge 402. The recorded data from the strain gauge 402 is maintained within the memory 414. The microcomputer 412 provides the ability to identify and address data packets that will be transmitted from the strain acquisition hardware and sensor(s) 214 to the valve monitoring server 210. The data is transmitted over either the WiFi interface 416 or wireline ethernet interface 418 through a digital network to the valve monitoring server 210 where the data is synchronized.

The strain acquisition hardware and sensor(s) 214 must provide precision excitation to each of the two strain bridges, one for thrust and one for torque. These bridges will be full Wheatstone Bridges constructed from 350-5000 ohm strain gauges. The excitation is to be fixed between 2-10 V. The excitation may be shared between the two bridges. The bridge output will be 10 mV/V where the mV is the full-scale output, and the V is the excitation voltage. The strain acquisition hardware and sensor(s) 214 must have two spare analog input channels available for future expansion. These channels should have an input range of ±10 volts. The strain acquisition hardware and sensor(s) 214 must have a “minimal installation” footprint. Enclosure dimension should not exceed the minimum space needed for mounting internal components while providing adequate cooling. Installation on a given actuator of a MOV 102 must be generic (i.e., installs the same way on all actuators of any given size). Mounting to the top of the stem cover (NTP threaded) is acceptable. Weight and installation location should have minimal impact on the valve/actuator assembly center of gravity. Installation must fit within the existing X-Y footprint of the valve/actuator assembly.

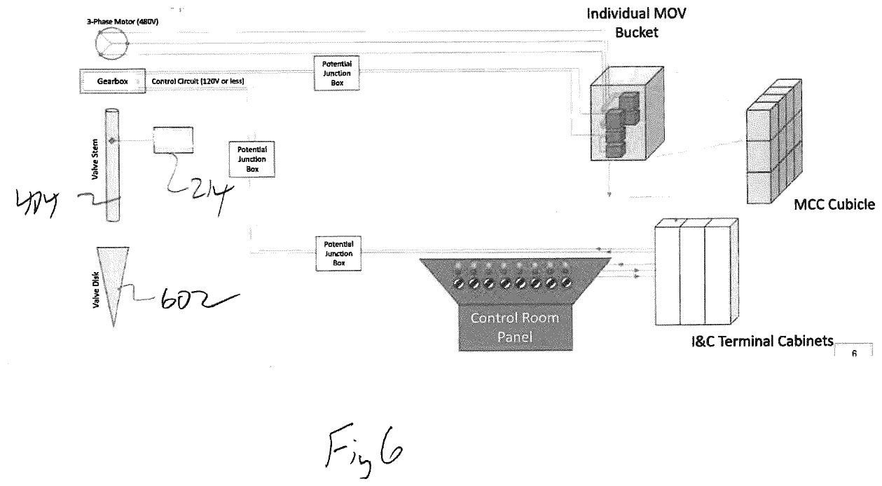

Referring now to FIG. 5, there is illustrated the switch actuation sensor 216 that monitors a closed control wire 502 and an open control wire 504 to monitor for actuation of the switch associated with the MOV 102. Control and I to V circuit 506 monitors for voltage and current indications of the actuation of the switch associated with the MOV 102. The analog to digital converter 508 converts analog signals from the circuit 506 into digital format. The digital to analog converter 510 converts signals from the microcomputer 512 from digital to an analog format. A memory 514 is used for storing data monitored with respect to the MOV 102. As before, data can be recorded within the memory 514 that is to be transmitted onward to the valve monitoring server 210 or may be temporarily stored therein in a memory buffer in the memory 514. The microcomputer 512 controls the operation of the switch actuation sensor 216 and is responsible for recording and storing data from the control wires 502/504 within the memory 514. The switch actuation sensor 216 may communicate with the VLAN 218 or nuclear powerplant network through a WiFi interface 516 or a wired ethernet interface 518. Power is provided to the switch actuation sensor 216 through power circuitry/interface 520.

The switch actuation sensor 216 provides signal conditioning and the means to record control circuit signals. The analog to digital converter 508 and digital to analog converter 510 digitize and time stamp each data point of the multiple strain signals received from the control circuit signals. The recorded data from the control circuit signals is maintained within the memory 514. The microcomputer 512 provides the ability to identify and address data packets that will be transmitted from the switch actuation sensor 216 to the valve monitoring server 210. The data is transmitted over either the WiFi interface 516 or wired ethernet interface 518 through a digital network to the valve monitoring server 210 where the data is utilized.

The switch actuation sensor 216 must collect switch actuation data. Switch actuation will be determined by detecting the presence (or absence) of current in the control circuit, with a current transducer around the control wires. The switch actuation sensor 216 should utilize as close to the same electronics as the strain acquisition hardware and sensor(s) 214. The switch actuation sensor 216 must have two spare voltage input channels available for future expansion.

Referring now to FIG. 6, there is illustrated the placement of the strain acquisition hardware and sensor(s) 214 within the overall system. The strain acquisition hardware and sensor(s) 214 is located close to the MOV 102 such that it can be connected to the valve stem 404 that connects with the valve disc 602. As discussed previously, the strain acquisition hardware and sensor(s) 214 is connected to the strain gauge 402 that is attached to the valve stem 404 via four wires and may utilize either two or four gauges. A single wire bundle connects the strain acquisition hardware and sensor(s) 214 to the strain gauges on the valve stem 404. The strain acquisition and hardware sensor(s) 214 are connected to the strain gauge attached to the valve stem 404 using 4 wires. Either 2 or 4 gauges will be used. A single wire bundle connects the strain acquisition hardware and sensor(s) 214 to the strain gauges on the valve stem 404 (8-16 wires).

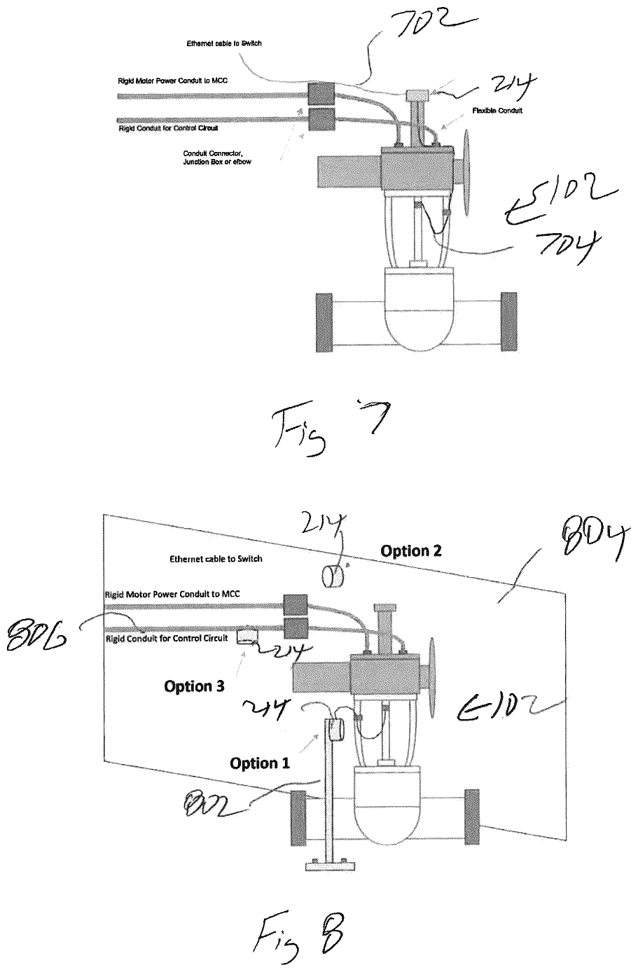

Referring now to FIG. 7, there is more particularly illustrated the manner for connection of the strain acquisition hardware and sensor(s) 214 to the MOV 102. The strain acquisition hardware and sensor(s) 214 has a wired ethernet cable 702 that connects the strain acquisition hardware and sensor(s) 214 to the network. By installing the strain acquisition hardware and sensor(s) 214 on the MOV 102, the potential effects on seismic analysis are avoided by the sensors size, weight and effect on center of gravity remaining equivalent to the existing MOV alone component. The MOV electrical qualification concerns are avoided when the control signals from the strain acquisition hardware and sensor(s) 214 are monitored elsewhere rather than at the strain acquisition hardware and sensor(s) connected to the MOV 102. The wiring harness for the strain acquisition hardware and sensor(s) 214 requires the ethernet cable 702 from the switch to the strain acquisition hardware and sensor(s) 214 and a strain gauge cable 704 connected to the strain gauge on the valve stem 404.

Referring now to FIG. 8, there are illustrated a variety of other options for location of the strain acquisition hardware and sensor(s) 214. As can be seen, the strain acquisition hardware and sensor(s) 214 can be mounted on a mounting member 802 located near the MOV 102 in a first option. In a second option, the strain acquisition hardware and sensor(s) 214 can be mounted on a surface such as a wall 804 near the MOV 102. In a third option, the strain acquisition hardware and sensor(s) 214 can be mounted on a rigid conduit for the control circuit. By installing the strain acquisition hardware and sensor(s) 214 near the MOV 102, the implementation avoids all actuator engineering evaluation requirements. Nearby structures to facilitate the mounting of the strain acquisition hardware and sensor(s) 214 include a pedestal or mounting member 802 located near the MOV 102 (option one). A nearby wall 804 or I-beam (option two), clamped to an incoming rigid conduit 806 (option three), using an appropriate wiring harness and drawings or an ethernet cable from the switch to the strain acquisition hardware and sensor(s) 214.

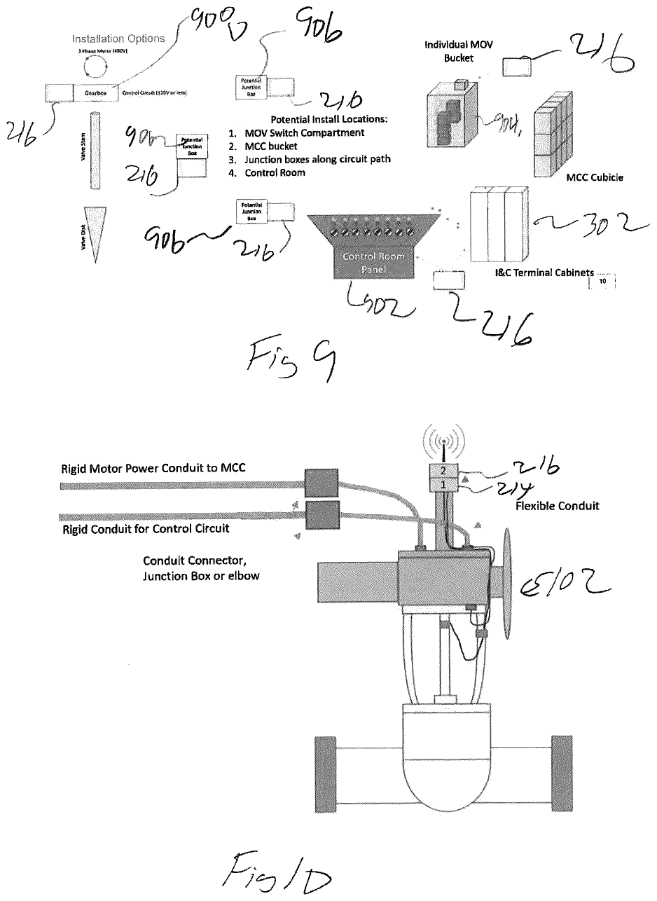

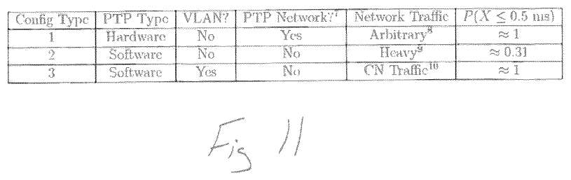

Referring now to FIG. 9, there are illustrated various options for location of the switch actuation sensor 216. These options include being mounted with the IC terminal cabinets 302 as discussed previously or within the control panel 902. In a further option, the switch actuation sensor 216 can be mounted with the individual MOV bucket 904. In a further embodiment the switch actuation sensor 216 can be mounted with any of the junction boxes 906. In a final option, the switch actuation sensor 216 can be associated with the gearbox 908 associated with the MOV switch compartment.

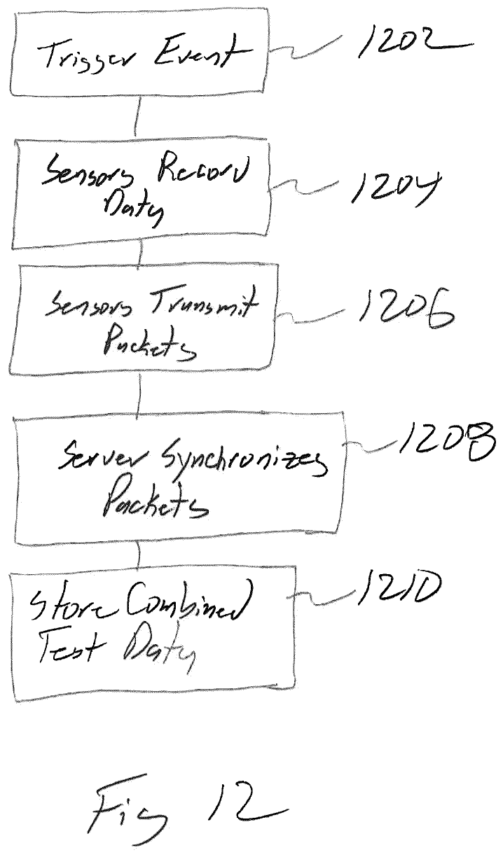

Referring now to FIG. 10, there is illustrated an alternative embodiment wherein the strain acquisition hardware and sensor(s) 214 and the switch actuation sensor 216 are both located together at the MOV 102. The power for the MOV 102 uses spare conductors in the MOV control circuit. This implementation also requires MOV electrical qualification analysis. The implementation of FIG. 10 would also require WiFi data communication using the existing plant WiFi system. Data would be routed to the Fleet monitoring system and pilot data would be stored in the monitoring system Pi historian or other types of data historians.

Referring now to FIG. 11, there is more particularly illustrated information related to the synchronization processes used for synchronizing the data between the strain acquisition hardware and sensor(s) 214 and the switch actuation sensor 216. The strain acquisition hardware and sensor(s) 214 and the switch actuation sensor 216 often record data at slightly different times. When this recorded data is provided from the sensors 214/216 to the valve monitoring server 210, the data must be aligned and synchronized such that the strain data associated with a particular switch actuation is paired together to provide an appropriate test data record with respect to the operation of the MOV 102. This is to enable the valve monitoring server 210 to know the actual thrust and torque of the MOV 102 when the switch controlling the MOV is closed. The valve monitoring server 210 must be capable of synchronizing acquired data samples from all channels within a maximum period of time of 0.0005 seconds. The combining and synchronizing of data collected across multiple locations from multiple sensors may be achieved using a post processing method providing the 0.0005 second precision can be maintained. The server 210 must provide the capability to synchronize the data sets in the event that the network is not available for a predetermined period of time during a valve actuation.

One manner for achieving synchronization between the strain acquisition hardware and sensor(s) data and the switch actuation sensor data utilizes the IEEE 1588 protocol. If all system hardware at the nuclear power plant is IEEE 1588 compliant, then hardware synchronization may be used to align the strain acquisition hardware and sensor(s) data with the switch actuation sensor data. However, many existing nuclear power plants have older hardware equipment that is not IEEE 1588 compliant. Thus, there is a need within such systems to achieve synchronization using other techniques. Other techniques may use a combination of the VLAN 218 for communications between the strain acquisition hardware and sensor(s) 214, the switch actuation sensor 216 and the valve monitoring server 210 with a software based precision time protocol (PTP).

FIG. 11 illustrates various configurations of the use of PTP software processing with a VLAN network to illustrate the improvement and operation of the system synchronization. The use of software PTP is not normally as effective as hardware PTP but many nuclear power plants do not have hardware PTP capabilities and thus some improvements may be achieved by the use of software PTP. When performing hardware PTP, all of the networking related hardware including the NIC at the PTP masters and clients, switches within the network and routers must be PTP compliant. This requirement will not be met at most nuclear power plants. Without PTP compliant hardware, the system must rely upon the less performant variant of PTP called software PTP. The big difference between software PTP and hardware PTP is that the time stamps are generated at the higher end of the network stack further away from the NIC in software PTP.

As can be seen in FIG. 11, three implementations consisting of different configurations were considered. These implementations show various combinations of software PTP, hardware PTP and the use of VLANs. As can be seen, in the first configuration type, a hardware PTP system is used with no VLAN in a PTP network. This provides the best results. The second configuration uses software PTP with no VLAN and no PTP network. The results of this are worse than those provided by the PTP hardware network. Finally, the third configuration utilizes software PTP along with a VLAN and no PTP network. This configuration provide similar results to those of the configuration using only PTP hardware. Thus, use of software PTP processing along with a VLAN for communications between the valve monitoring server 210, the strain acquisition hardware and sensor(s) 214 and the switch actuation sensor 216 can provide similar synchronization ability to a to a network implementing hardware PTP.

Given the results determined from the above configurations it is clear that software PTP is not as performant as hardware PTP. In fact, without a VLAN being provided, software PTP will not enable meeting the synchronization requirements of 0.5 ms between the sensors. However, with a VLAN, software PTP improves and as a result the improvements enable the meeting of the 0.5 ms time synchronization requirement.

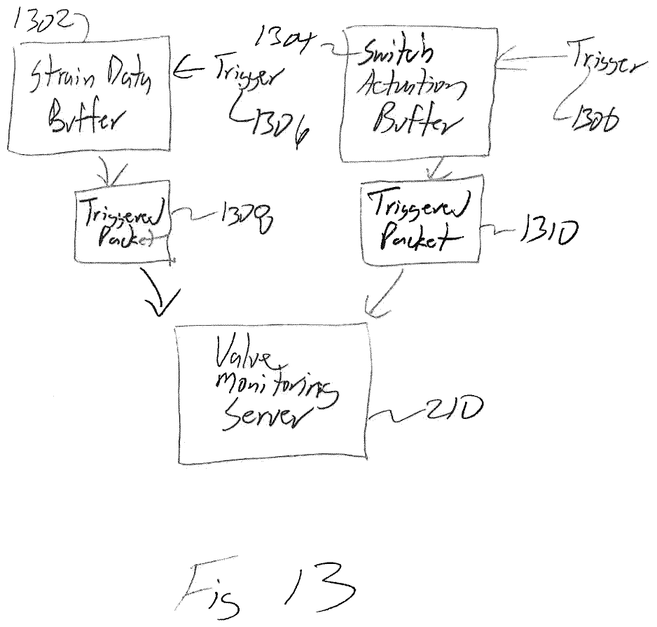

Referring now to FIG. 12, there is illustrated a flow diagram of the process for synchronizing data from the strain acquisition hardware and sensor(s) 214 and the switch actuation sensor 216. A triggering event occurs at step 1202 within the MOV 102. This triggering event causes the sensors to record at step 1204 the strain data at the strain acquisition hardware and sensor(s) 214 and the switch actuation data at the switch actuation sensor 216. The recorded strain data and switch actuation data are then transmitted at step 1206 as separate packets from the sensors 214/216 over the VLAN to the valve monitoring server 210. The valve monitoring server uses the PTP processing to synchronize at step 1208 the separate packets from the strain acquisition hardware and sensor(s) 214 and the switch actuation sensor 216 to create a single combined test data record. The combined test data record is then stored in memory at step 1210.

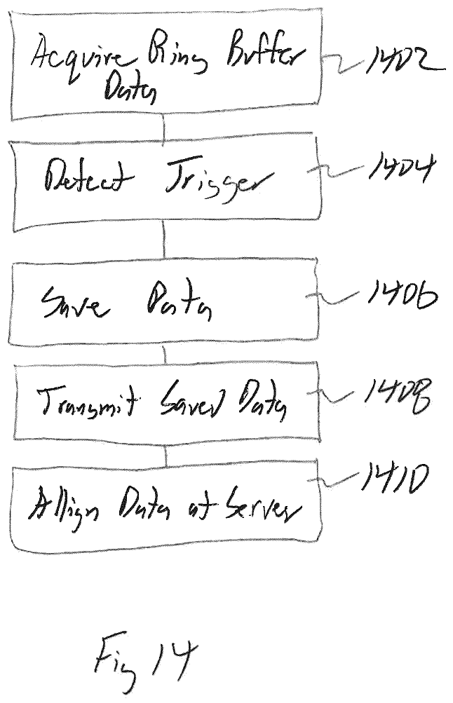

Referring now to FIG. 13, there is illustrated the manner in which the strain acquisition hardware and sensor(s) 214 and switch actuation sensor 216 may be actuated to record a data point with respect to operation of the MOV 102. Data is continuously stored on a temporary basis within a strain data buffer 1302 associated with the strain acquisition hardware and sensor(s) 214 and the switch actuation data buffer 1304 associated with the switch actuation sensor 216. Each of these buffers 1302, 1304 continuously store data with respect to the MOV 102 that the sensors 214, 216 are monitoring. In most cases, the data will merely rotate through the buffers 1302, 1304 without being finally recorded as a test data point. However, upon receipt of a particular trigger 1306 which will be more fully described herein below, each of the strain data buffer 1302 and the switch actuation buffer 1304 will provide a packet of data 1308, 1310 that is transmitted to the valve monitoring server 210. The valve monitoring server 210 will align the received data packets and store them as a test data point within the memory associated with the valve monitoring server 210.

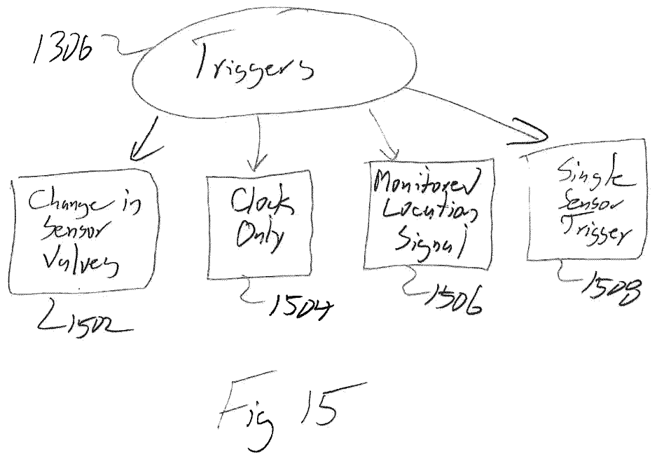

This process is illustrated in the flow diagram of FIG. 14. The ring buffers 1302, 1304 are continuously filled with data at step 1402 responsive to the continuous monitoring of the associated MOV 102. This occurs for both the strain acquisition hardware and sensor(s) 214 and the switch actuation sensor 216. The sensors 214, 216 will then react to a detected trigger at step 1404 which will cause saving of the data at step 1406 associated with the trigger point that is then transmitted at step 1408 from the respective strain acquisition hardware and sensor(s) 214 and the switch actuation sensor 216 to the valve monitoring server 210. The received data packets from the sensors 214, 216 may then be aligned at the server at step 1410 to create a test data record that is stored at the server 210 within a memory.

Referring now to FIG. 15, a variety of different triggers 1306 may be used to actuate the sensors 214/216 to record and/or transmit data packets from the associated buffer 1302, 1304 to the valve monitoring server 210. These triggers include changes in sensor values 1502 at either of the strain acquisition hardware and sensor(s) 214 or the switch actuation sensor 216, clock only triggers 1504 based upon a system clock, monitored signals trigger 1506 at either of the strain acquisition hardware and sensor(s) 214 or the switch actuation sensor 216, single sensor triggering 1508 where one sensor actuates the other sensor or any other reasonable manner for triggering the record lead transmission of data to the server 210.

Changes in sensor values 1502 can be based upon the transition of the strain values at the strain acquisition hardware and sensor(s) 214 that occurs with the MOV 102 opening stroke or closing stroke. When the MOV 102 is opened, values will go high and then back down to low when the opening stroke is completed. This will cause a corresponding change in the switch actuation sensor 216 which will go from 0 A to 1 A responsive to actuation of the switch. Similarly, when the MOV closing stroke occurs, the strain value will go from low to high. Detection of any of these occurrences may be used as a means for actuating recording of the data within the buffer 1302/1304 and transmission of the triggered packets 1308/1310 to the valve monitoring server 210.

The clock only trigger 1504 involves systems that are updated enough such that their hardware clocks accurately track time between the sensors and the data associated with the clock time may be transmitted to the valve monitoring server 210. The monitored signals trigger 1506 involves monitoring a signal that is available at each of the strain acquisition hardware and sensor(s) 214 and switch actuation sensor 216 and when predetermined changes occur in the monitored signal, recording of the data within the buffers 1302/1304 and their transmission to the valve monitoring server 210 may be initiated. An example of this is the motor current signal but other signals may be utilized. Triggering based upon a single sensor 1508 involves detection of actuation of the strain acquisition hardware and sensor(s) 214 or the switch actuation sensor 216. If actuation of either of these sensors is detected, the actuated sensor will transmit a signal to the other sensor to cause the other sensor to record and transmit the center data associated with actuation at the first sensor.

In the event of an actuation responsive to a trigger, the system must record data from all utilized channels for a minimum of 60 seconds before the stroke starts to 60 seconds after the stroke ends. This will ensure that all of the relevant data with respect to the MOV stroke is recorded. The data acquisition system must provide the capability to locally store a minimum of 25 stroke cycles of data until successfully retrieved from the sensor 214/216. The data acquisition system must support local retrieval of data either through physical removal of storage media from the sensors 214/216 or a local transfer via a wireless or wired connection. The data acquisition system must retain all locally store data in the event of a power outage of indefinite time duration. A small internal rechargeable battery may be used to meet this requirement. The battery shall be charged automatically by the system. The data acquisition system must support data collection over power cables to the data acquisition system. Power conductivity to the MOV 102 may not be used for this data transfer functionality. Sensor data collected at the MOV 102 shall be captured by the data acquisition system within 0.5 ms of an MOV stroke activation. If switch current and strain data are captured by separate hardware, the 0.5 ms requirement may be obtained via high-speed network connection or timestamp correlation.

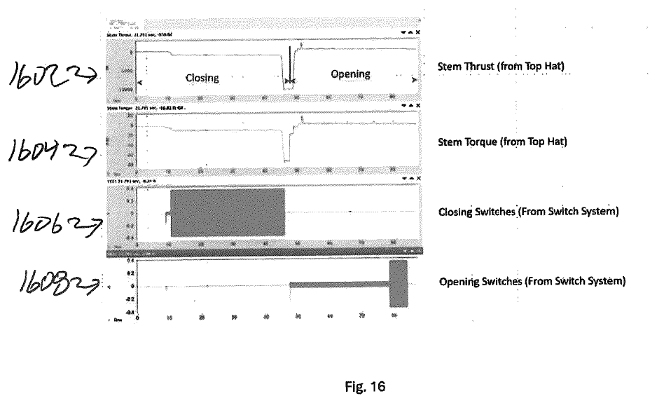

Referring now to FIG. 16, there is illustrated the readings from the strain acquisition hardware and sensor(s) 214 and switch actuation sensor 216 responsive to various operations. The stem thrust for the strain acquisition hardware and sensor(s) 214 is illustrated generally at 1602. The stem torque for the strain acquisition hardware and sensor(s) 214 is illustrated generally at 1604. The closing of a switch for the switch actuation sensor 216 associated with the MOV 102 is illustrated generally at 1606. The opening of a switch for the switch actuation sensor 216 associated with the MOV 102 is illustrated generally at 1608.

It may be advantageous to set forth definitions of certain words and phrases used throughout this patent document. The term “couple” and its derivatives refer to any direct or indirect communication between two or more components, whether or not those components are in physical contact with one another. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present disclosure should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A system for synchronizing test data for a motor operated valve associated with a nuclear power plant, comprising:
at least one strain acquisition hardware and sensor located at the motor operated valve for generating strain data responsive to actuation of the motor operated valve;
at least one switch actuation sensor separate from the at least one strain acquisition hardware and sensor for generating switch actuation data responsive to actuation of a switch of the motor operated valve;
a valve monitoring server for receiving the strain data from the strain acquisition hardware and sensor and the switch actuation data from the at least one switch actuation sensor, wherein the valve monitoring server is configured to process the received strain data and the received switch actuation data to provide precision alignment in time of the separately generated strain data and switch actuation data; and
a network for enabling transfer of the strain data and the switch actuation data between the at least one strain acquisition hardware and sensor, the at least one switch actuation sensor and the valve monitoring server.

2. The system of claim 1 further comprising:
a first buffer associated with the at least one strain acquisition hardware and sensor for continuously storing the generated strain data;
a second buffer associated with the at least one switch actuation sensor for continuously storing the generated switch actuation data; and
wherein a first currently stored packet of the strain data within the first buffer and a second currently stored packet of the switch actuation data within the second buffer are transmitted to the valve monitoring server responsive to receipt of a trigger by the strain acquisition hardware and sensor and the at least one switch actuation sensor.

3. The system of claim 2, wherein the trigger comprises at least one of a change in sensor values at either of the strain acquisition hardware and sensor and the at least one switch actuation sensor.

4. The system of claim 2, wherein the trigger comprises a hardware clock signal.

5. The system of claim 1, wherein the network further comprises a precision time protocol network, further wherein the valve monitoring server is further configured to communicate with the at least one strain acquisition hardware and sensor and the at least one switch actuation sensor using a hardware based precision time protocol.

6. The system of claim 1, wherein the valve monitoring server is further configured to communicate with the at least one strain acquisition hardware and sensor and the at least one switch actuation sensor using a software based precision time protocol.

7. The system of claim 1, wherein the network comprises a virtual local area network, further wherein the virtual local area network is further configured to communicate with the at least one strain acquisition hardware and sensor and the at least one switch actuation sensor using a software based precision time protocol.

8. A system for actuating recording of valve test data for a motor operated valve associated with a nuclear power plant, comprising:
at least one strain acquisition hardware and sensor for continuously recording strain data associated with the motor operated valve;
at least one strain acquisition hardware and sensor buffer each associated with the at least one strain acquisition hardware and sensor for storing the continuously recorded strain data on a temporary basis;
a switch actuation sensor for continuously recording switch actuation data associated with the motor operated valve;
a switch actuation sensor buffer associated with the switch actuation sensor for storing the continuously recorded switch actuation data on a temporary basis;
a valve monitoring server in communication with the at least one strain acquisition hardware and sensor and the switch actuation sensor; and
wherein each of the at least one strain acquisition hardware and sensor switch actuation sensor and the switch actuation sensor are responsive to a triggering event to store and transmit a portion of the recorded strain data in the at least one strain acquisition hardware and sensor buffer and a portion of the recorded switch actuation data in the switch actuation sensor buffer to the valve monitoring server.

9. The system of claim 8, wherein the valve monitoring server is further configured to synchronize the portion of the recorded strain data with the portion of the recorded switch actuation data.

10. The system of claim 9 further comprising a memory for storing synchronized strain data and switch actuation data.

11. The system of claim 8, wherein the triggering event comprises a change in a sensor value of at least one of the at least one strain acquisition hardware and sensor and the switch actuation sensor.

12. The system of claim 8, wherein the triggering event comprises a periodic occurrence of a system clock signal.

13. The system of claim 8 wherein the triggering event comprises an occurrence of a predetermined signal at one of the at least one strain acquisition hardware and sensor and the switch actuation sensor.

14. A system for continuously monitoring a motor operated valve within a nuclear power plant, comprising:
at least one strain acquisition hardware and sensor located on the motor operated valve for detecting strain data associated with the motor operated valve and generating first test data responsive thereto;
a switch actuation sensor remotely located from the motor operated valve for detecting actuation of a switch for actuating operation of the motor operated valve and generating second test data responsive thereto;
a server connected to the at least one strain acquisition hardware and sensor and the switch actuation sensor for associating the first test data and the second test data with a same actuation event and storing the associated test data;
a memory for storing the associated first test data and the second test data; and
a network for providing communications between the at least one strain acquisition hardware and sensor, the switch actuation sensor and the server.

15. The system of claim 14, wherein the at least one strain acquisition hardware and sensor further comprises:
a strain gauge associated with a valve stem of the motor operated valve to detect strain within the motor operated valve and generate a strain signal responsive thereto;
strain circuitry for generating the strain data responsive to the strain signal; and
a communication interface enabling communications between the at least one strain acquisition hardware and sensor.

16. The system of claim 14, wherein the switch actuation sensor monitors an open control wire and a closed control wire to detect actuation of the switch associated with the motor operated valve.

17. The system of claim 14, wherein the at least one strain acquisition hardware and sensor is mounted to a valve stem of the motor operated valve.

18. The system of claim 14, wherein the switch actuation sensor is mounted at a location associated with a control circuit of the motor operated valve.

19. The system of claim 14, wherein the network comprises a virtual local area network for transmitting data between the at least one strain acquisition hardware and sensor, the switch actuation sensor and the server.

20. The system of claim 14, wherein the server is further configured to communicate with the at least one strain acquisition hardware and sensor and the switch actuation sensor using a hardware based precision time protocol.
